(19) United States
(12) Patent Application Publication
(10) Pub. No.: US 2018/0205864 A1
(43) Pub. Date: Jul. 19, 2018

(54) Camera Mounted LED Telephoto Spotlight

(71) Applicant: Kenneth Harden, Eden Prairie, MN (US)

(72) Inventor: Kenneth Harden, Eden Prairie, MN (US)

(73) Assignee: BBY SOLUTIONS, INC., Richfield, MN (US)

(21) Appl. No.: 15/407,286

(22) Filed: Jan. 17, 2017

(51) Int. Cl. H04N 5/235; H04N 5/232; H04N 5/225

(52) U.S. Cl. CPC H04N 5/2354; H04N 5/2251; H04N 5/23216

(57) ABSTRACT

A flash mechanism and photography illumination system includes a housing, having a user interface and containing a light assembly, a power source, and a control module. The mechanism includes a manual zoom mechanism engaged to the housing and which is in communication with the light assembly. The mechanism has at least two illumination modes. A first mode wherein a light source provides a beam of illumination at a first illumination level to find and properly light a subject; and a second mode wherein a light source provides a momentary flash of high intensity illumination at a second illumination level greater than the first illumination level.

### FIELD OF THE INVENTION

The field of the present disclosure is that of flash photography, and a flash device for use in night-time or low light photography conditions. With particular applicability when attempting to illuminate and photograph a subject at relatively long distances under such low light conditions.

### SUMMARY

Embodiments of the present disclosure are directed to a flash mechanism (hereinafter a flash) and cameras (video cameras, still photography cameras, electronic devices capable of capturing images, etc.) equipped with such a flash, wherein the flash has at least two illumination modes that may be utilized separately or together.

A first mode provides a beam of light (i.e. a spotlight) for initially illuminating a distant area in low light conditions at ranges of from under 100 feet to at least 1000 feet from the camera/flash assembly. The first mode of illumination may be a low light or low power use mode, whereby the beam of illumination may be adjusted manually by the user to focus the beam of illumination, direct it, increase or decrease its intensity, etc. so as to properly locate, and light a potential photography subject in low light conditions and at even considerable distances from the camera/flash assembly. The first mode has a light output of about 200 to about 2000 lumens.

The flash also has a second or flash mode which provides a temporary overall increase in the illumination level of the spotlight and/or triggers a secondary illumination source to provide increased illumination to the area surrounding the subject in the manner of a camera “flash”. The intensity and illumination characteristics of the flash mode may be manually adjusted by a user or automatically regulated/optimized for specific lighting conditions and effects. The flash mode may be used at the same time or subsequent to the use of the spotlight mode or may be activated without first utilizing the spotlight mode. The second mode has a light output greater than that of the first mode and may be in excess of 2000 lumens.

In some embodiments the modes and their various attributes are manually controlled via controls on the flash housing. In some embodiments the modes and their various attributes are in electronic and/or mechanical interface with the camera and are controlled therefrom.

Embodiments of the flash described herein provide a unique illumination system which allows a user to locate and illuminate a potential subject for photography under dark or low light conditions using a relatively low power but consistent and/or constant source of illumination via the first illumination mode. This low power spotlight may be supplemented when the actual picture is taken by a high intensity flash of additional or increased illumination via the engagement of the second illumination mode. This two mode system provides both novel illumination modes for improved night photography performance over existing flash mechanisms, but also provides improved power consumption characteristics by allowing the flash to function as a low power spotlight to locate and light the subject before having to activate the higher power/illumination flash.

### BRIEF DESCRIPTION OF THE DRAWINGS

FIG. 1 is a sectional view of an embodiment of a flash device, showing the various components thereof.

FIG. 2 is an exterior, front view of the flash device shown in FIG. 1.

FIGS. 3a and 3b are an exterior side view of the flash device of FIGS. 1-2 shown as part of a camera and flash assembly, and illustrating a manual control interface for focusing a light beam emitted from the flash device when in a first mode of operation.

FIGS. 4a and 4b depict the same assembly as in FIGS. 3a and 3b but wherein the beam focus of the flash device is being controlled by user interface with the controls of the camera.

FIG. 5a is a block diagram showing the electronic communication between a camera and flash as depicted in FIGS. 4a-4b.

FIG. 5b is a diagrammatic view of the user control interface shown in FIG. 5a.

FIGS. 6a and 6b depict the assembly of FIGS. 3a-4b in an environment of use and illustrating the manner in which the first lighting mode may be used to locate and focus on a subject.

FIGS. 7a and 7b depict the same assembly as in FIGS. 4a and 4b but wherein a second lighting mode of the flash device is shown being triggered by user interface of the controls of the camera.

FIGS. 8a-8b depict the assembly of FIGS. 7a-7b in an environment of use and the first and second lighting modes shown in operation.

### DETAILED DESCRIPTION

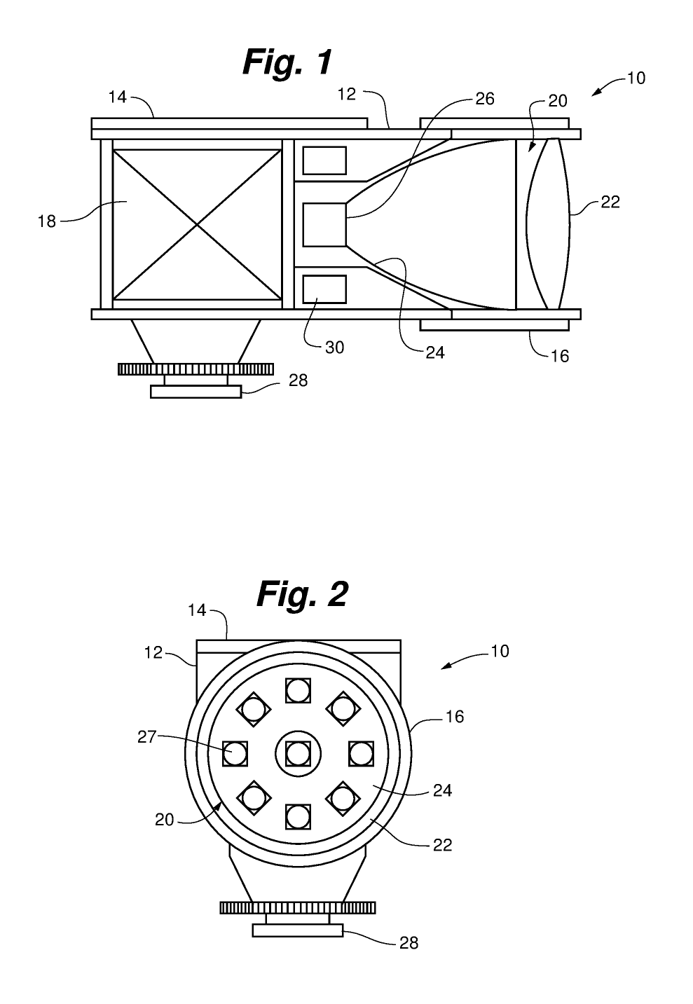

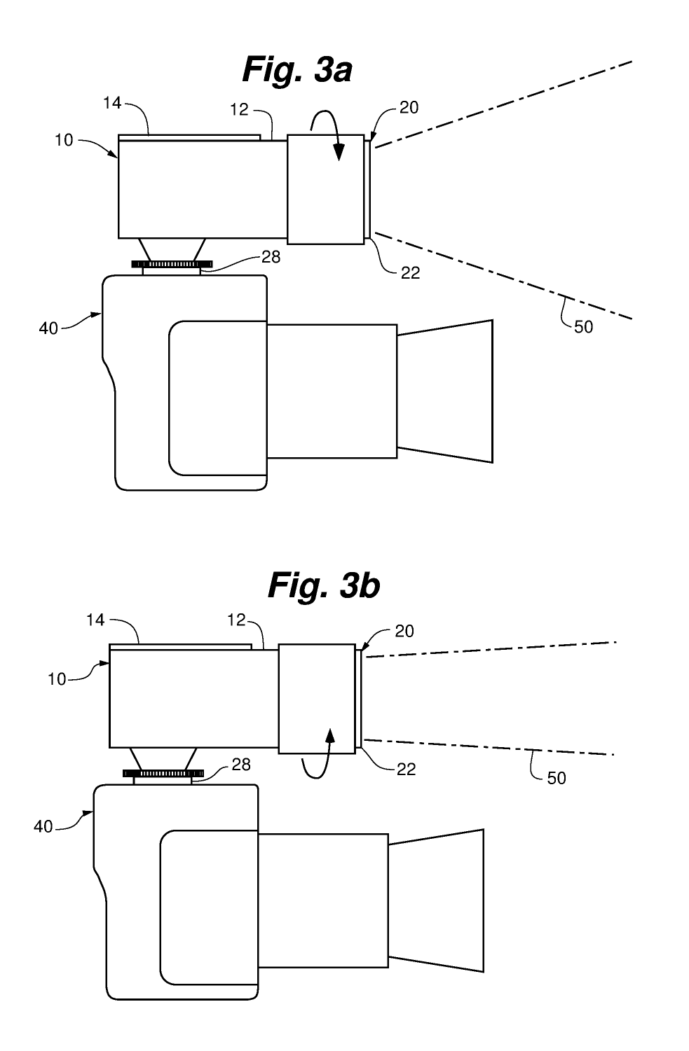

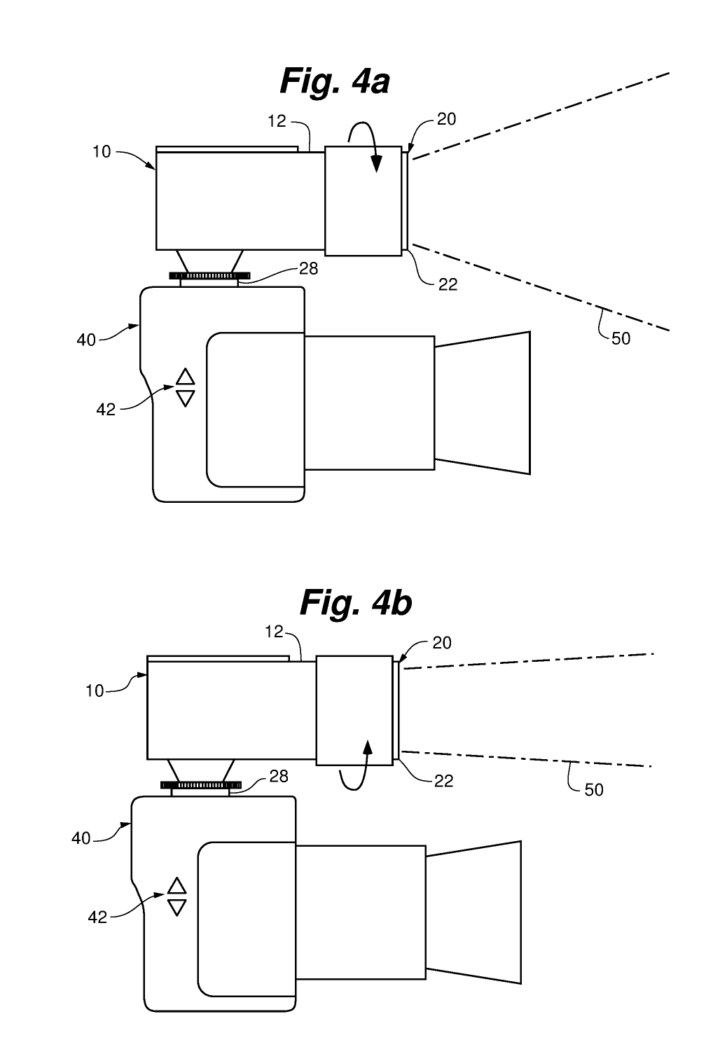

As mentioned above, embodiments of the present disclosure are directed to a flash 10 an example of which is shown in FIG. 1. Flash 10, includes a flash housing 12, a user control interface 14 on an external surface of the housing 12, a manual zoom mechanism 16 engaged to the housing 12 and which provides a direct control for the focus of a beam of illumination (Shown in FIGS. 3a-4b) during at least one mode of operation (discussed in greater detail below), wherein the beam of illumination is provided by a light assembly 20 and associated power supply (e.g. batteries, battery pack, AC or DC power sources, etc.) 18 in electronic communication therewith.

Light assembly 20 includes one or more lenses 22 in communication with the zoom mechanism 16, a reflector 24 and at least one light source 26. Light source 26 may be one or more light emitting diodes (LED), filament lights, chemical illuminants, etc.

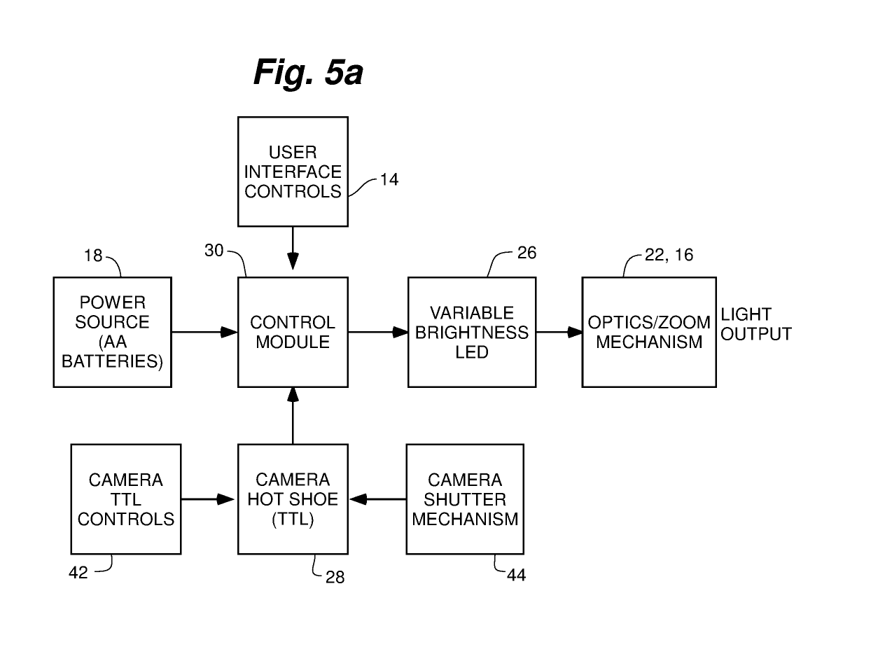

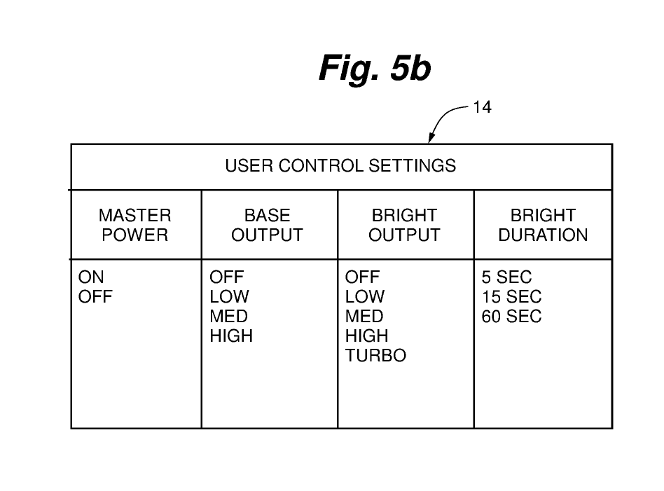

Flash 10, includes control electronics or control module 30 which controls the inputs received from the user interface 14, as well as from the through-the-lens controls 42 of a camera 40 (shown in FIGS. 4a-4b) via the hot shoe mount 28 of the flash housing 12. An embodiment of the electronic pathways through which the control module 30 directs inputs to control the brightness of the light source 26 is depicted in FIG. 5. An embodiment of the user control interface 14 with an example of specific illumination attributes and flash functions that may be adjusted or customized is shown in the table of FIG. 5b.

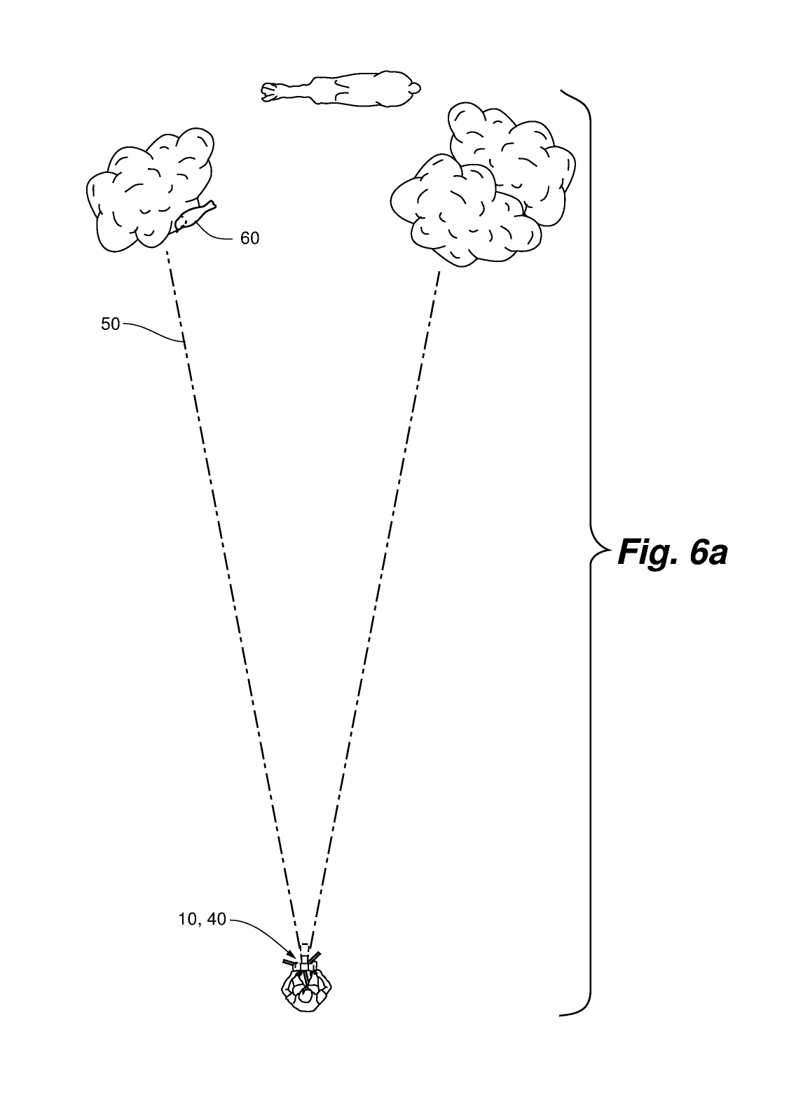

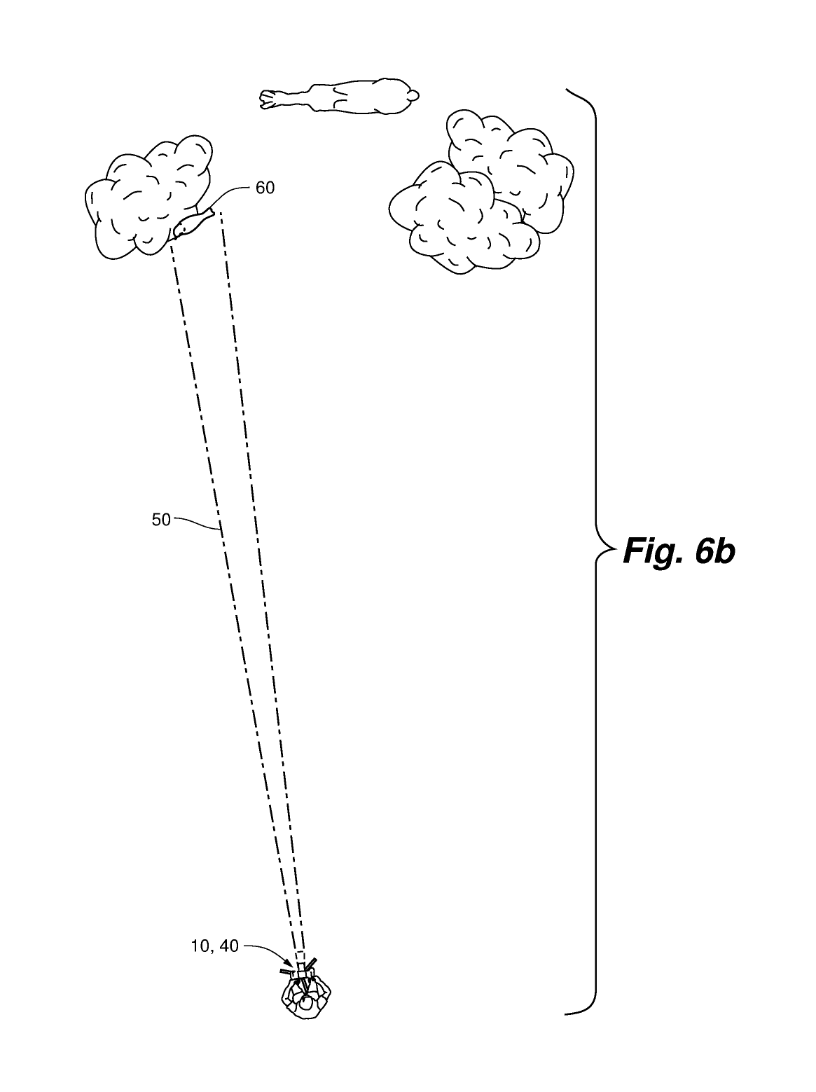

In terms of that functionality: the flash 10 has a first illumination mode, depicted in FIGS. 3a-3b, 4a-4b, and 6a-6b, wherein the light assembly 20 function as a search or spot light which may be utilized to illuminate a relatively wide area or field of view such as in the manner shown in FIG. 6a. The intensity of the illumination “beam” 50 may be controlled directly via the user control interface 14 on the flash housing 12 and/or may be controlled using the controls 42 of the camera 40 to which the flash 10 is engaged both mechanically and electronically via the hot shoe interface 28, such as in the manner shown in FIGS. 4a-4b.

As is depicted in FIG. 6a, once a subject 60 is located using a broad field of view setting in the first illumination mode, the beam 50 may be narrowed or focused onto a desired subject 60 such as in the manner shown in FIG. 6b. The focus of the illumination beam 50 may be directed via manual zoom control 16 of the flash optics or lens(es) 22 such as in the manner shown in FIGS. 3a-3b, or may once again be controlled via the TTL controls 42 of the camera 40 in the manner shown in FIGS. 4a-4b.

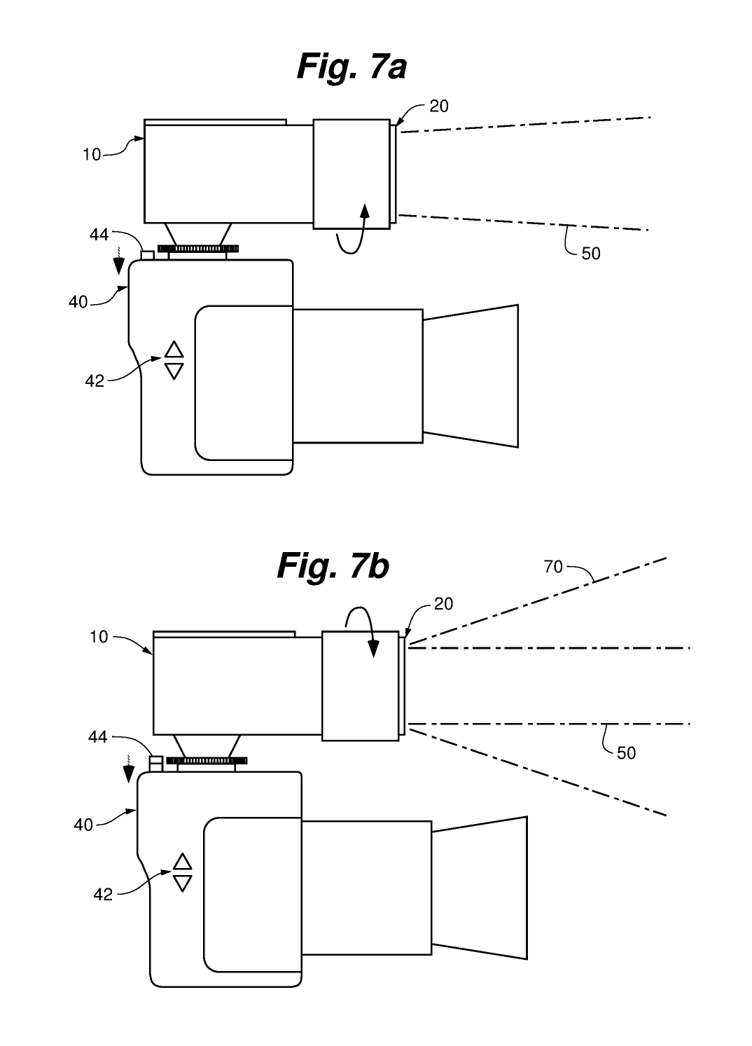

In at least one embodiment, shown in FIG. 7a, the first mode is engaged by pushing the shutter mechanism (button) 44 of the camera 40 half-way down (i.e. a partially depressed state). This sends a signal from the camera 40 to the electronic control module 30 of the flash 10 (see FIGS. 1 and 5), which in-turn activates the first illumination mode and turning on the spotlight beam 50.

Once the subject 60, is properly illuminated using the first illumination mode spotlight beam 50, and the manual and/or automatic controls/settings of the flash 10 and/or camera 40, the flash 10 and camera 40 may be placed into a second illumination or high intensity “flash” mode by fully depressing the shutter mechanism 44 in the manner in the manner shown in FIG. 7b, so as to take a picture with the camera 40 in a conventional manner.

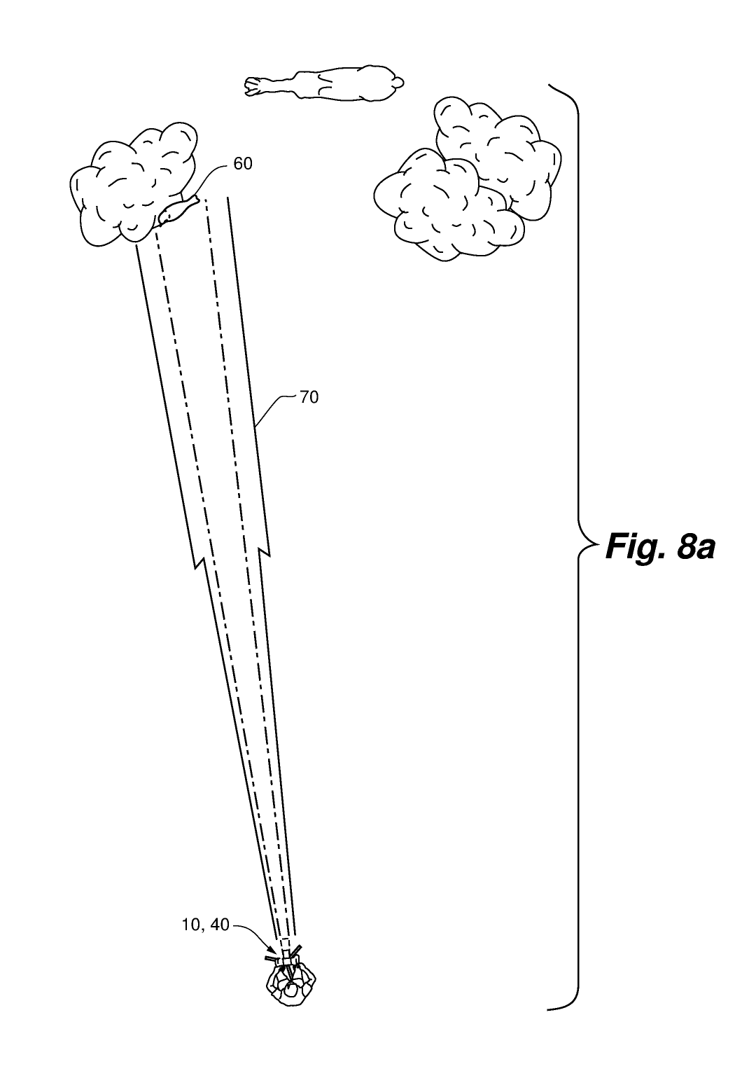

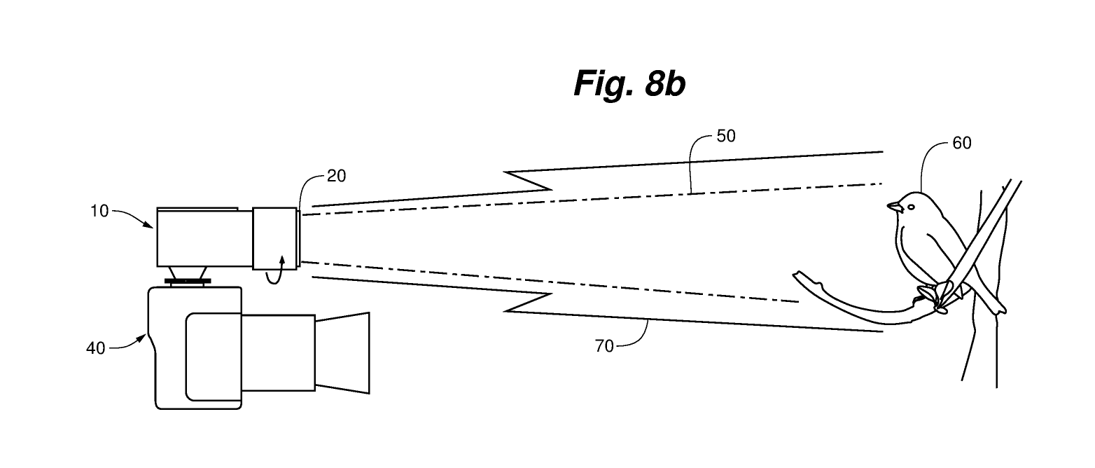

This full depression of the shutter mechanism 44 sends a signal from the camera 40 to the electronic control module 30 (see FIG. 5) of the flash 10 via the hot-shoe interface 28, which in-turn activates the second mode or flash functionality of the light assembly 20. This “flash” of illumination 70, such as is depicted in FIGS. 7b, and 8a-8b, may be provided by a command sent from the command module 30 to increase the electric current supplied to the light source 26, which is the source of both the beam 50 and flash 70, in a rapid and controlled manner of a traditional LED flash, thereby creating an additional increase in overall illumination (in the manner of a flash) 70.

Alternatively, in at least one embodiment, such as that shown in FIG. 2, the light assembly 20 includes a light source 26 which supplies the illumination for the spotlight of the first mode, and one or more secondary illumination sources 27 that are energized separately from the light source 26 when the flash 10 is placed into the second mode to provide the flash illumination 70 as shown in FIGS. 7b and 8a-8b.

In all embodiments the flash 10 may include various controls and features such as lens coatings, optical enhancements, filters, temperature control features to ensure optimize performance of the light sources, wireless controls for remote operation, etc.

Returning to the depiction of the user control interface 14 depicted in the table of FIG. 5b, the table shows an example of some ancillary illumination controls and settings that the user may select from and employ for various lighting purposes. In the embodiment shown, BASE setting is the ‘always on’ or low-output setting for finding/setting up the shot (e.g. first mode, but low intensity illumination). An example level of illumination could be about 200 to about 500 lumens. BRIGHT is the setting engaged when the user presses the camera shutter mechanism half-way down in the manner described above in FIG. 7a (e.g. first mode, but perhaps a higher illumination intensity than the BASE setting). An example level of illumination would be about 500 to about 1000 lumens of illumination. TURBO setting provides an illumination level in the range of about 1000 to about 2000 lumens.

In at least one embodiment the flash of illumination provided by the second illumination mode is the same as the highest level of illumination potentially provided by the first illumination mode or greater, but provided in a momentary flash of illumination rather than over an extended duration. Thus, in the embodiment above, the second illumination mode would provide illumination of at least 2000 lumens in an intense momentary flash. In some embodiments the level of illumination provided by the second illumination mode is greater than that of the intensity provided by the first illumination mode.

As is shown, within these BASE and BRIGHT settings, additional more finely tuned illumination levels may be provided with ranges of light output being predetermined or customizable by the user.

DURATION is how long the higher output of the BRIGHT setting remains on before reverting to the BASE setting so as to ensure maximum life of the battery (power source 18 shown in FIG. 1). The ability to actually DECREASE the light output is intentional—it allows the device to be used as a searchlight, then turned off for the actual shot (which could be desirable in some cases).

Other embodiments may include additional features such as providing the first mode and/or second mode light source(s) with tone or color variations, filter selections etc.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

1. A flash mechanism comprising:
a housing, the housing having a user interface and containing:
a light assembly, the light assembly comprising at least one light source, a reflector and at least one lens;
a power source in communication with the light assembly;
a control module for receiving and directing inputs from at least the user interface and for actuating and controlling the at least one light source in accordance with such inputs;
a manual zoom control engaged to the housing and in communication with the at least one lens;
the flash mechanism having a first illumination mode and a second illumination mode, in the first illumination mode the at least one light source providing a beam of illumination at a first illumination level, in the second illumination mode the at least one light source providing a momentary flash of high intensity illumination at a second illumination level, the second illumination level being greater than the first illumination level, the second illumination level being provided via an increase in current supplied to the at least one light source from the power source.

2. The mechanism of claim 1, wherein in the first illumination mode and in the second illumination mode the at least one light source is the same light source.

3. The mechanism of claim 1, wherein in the first illumination mode the at least one light source is a primary light source and in the second illumination mode the at least one light source is a secondary light source, the primary light source and the secondary light source being different sources of light.

4. The mechanism of claim 1, wherein the beam of illumination of the first illumination mode is configured to have an intensity within a range of about 200 lumens to about 2000 lumens; and the flash of high intensity light of the second illumination mode is at least 2000 lumens.

5. The mechanism of claim 1 wherein the manual zoom control is configured for control of the focus of the beam of illumination in the first illumination mode.

6. The mechanism of claim 5 wherein the user interface provides controls for the regulation of modes, power supplied to the at least one light source, level of brightness, and duration of illumination of at the beam of illumination and the flash of high intensity illumination of the first illumination mode and second illumination mode respectively.

7. The mechanism of claim 6 wherein the housing further comprises a hot shoe assembly for mechanical and electronic engagement to a camera.

8. The mechanism of claim 7, wherein the camera includes TTL controls, the TTL controls in communication with the control module, the TTL controls corresponding to at least some of the controls provided by the user interface and manual zoom control.

9. The mechanism of claim 8, wherein the camera includes a shutter mechanism, the shutter mechanism having a partially depressed state and a fully depressed state, in the partially depressed state the flash mechanism being placed in the first illumination mode, in the fully depressed state the flash mechanism being placed in the second illumination mode.

10. An assembly comprising a camera and a flash mechanically engaged to the camera via a hot shoe interface and in electronic communication there with, the assembly comprising:
a flash mechanism, the flash mechanism having:
a housing, the housing having a user interface and containing:
a light assembly, the light assembly comprising at least one light source, a reflector and at least one lens;
a power source in communication with the light assembly;
a control module for receiving and directing inputs from the the user interface and from TTL controls of the camera, for actuating and controlling the at least one light source in accordance with such inputs;
a manual zoom control engaged to the housing and in communication with the at least one lens;
the flash mechanism having a first illumination mode and a second illumination mode, in the first illumination mode the at least one light source providing a beam of illumination at a first illumination level, in the second illumination mode the at least one light source providing a momentary flash of high intensity illumination at a second illumination level, the second illumination level being greater than the first illumination level, the second illumination level being provided via an increase in current supplied to the at least one light source from the power source.
